(19) United States
(12) Patent Application Publication
(10) Pub. No.: US 2020/0349454 A1
(43) Pub. Date: Nov. 5, 2020

(54) LOGICAL CALCULATION DEVICE, LOGICAL CALCULATION METHOD, AND PROGRAM

(71) Applicant: NEC Corporation, Minato-ku, Tokyo (JP)

(72) Inventors: Yuki HAYASHI, Tokyo (JP); Jun SUZUKI, Tokyo (JP)

(73) Assignee: NEC Corporation, Minato-ku, Tokyo (JP)

(21) Appl. No.: 16/958,408

(22) PCT Filed: Dec. 18, 2018
(86) PCT No.: PCT/JP2018/046622

§ 371 Date: Jun. 26, 2020

(30) Foreign Application Priority Data
Dec. 27, 2017 (JP) 2017-252612

(51) Int. Cl. G06N 5/04; G06N 20/00

(52) U.S. Cl. CPC G06N 5/04; G06N 20/00

(57) ABSTRACT

A logical calculation device includes: an inclusion extraction unit that extracts a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

### TECHNICAL FIELD

The present invention relates to a logical calculation device, a logical calculation method, and a program that calculate a predicate logical formula.

### BACKGROUND ART

A logical network processing system that infers an event based on a plurality of logical formulas (also referred to as rules below) is known (for example, see Patent Document 1). The logical network processing system performs inference by substituting a known value (also referred to as input data below) into the respective rules.

In Patent Document 2, a technique is disclosed wherein, in a production system that infers an event based on a plurality of logical formulas (also referred to as rules below) expressed in the form of If (antecedent)-Then (consequent) statements, an accurate evaluation of the consequents of the rules is made with a predetermined degree of certainty. According to Patent Document 1, rules having the same consequent and whose antecedents have an inclusion relation are extracted, and, of the extracted rules, the rule having the highest degree of inclusion (the rule having the largest number of events in the antecedent) is executed.

### PRIOR ART DOCUMENTS

### Patent Documents

[Patent Document 1] Published Japanese Translation No. 2016-505953 of the PCT International Publication

[Patent Document 2] Japanese Unexamined Patent Application, First Publication No. H03-58230

### SUMMARY OF THE INVENTION

### Problem to be Solved by the Invention

In a logical network processing system, it is known that the calculation time increases as the number of rules increases. This is because, when the number of input rules increases, the logical network processing system performs substitution processing individually for each rule. For example, in a case where there are two rules such as “Friend(x, y)->Friend(y, x)” and “Friend (x, y)->Friend(y, z)”, although the rules are similar to each other, the argument (here, the second argument of the second predicate argument Friend) is different. Consequently, the substitution results have different values. As a result, the logical network processing system needs to perform a substitution operation individually for the two rules.

In the technique disclosed in Patent Document 2, when a rule group exists having the same consequents, and further, some of the antecedents have an inclusion relation, one rule is selected from them and then executed. In a case where the consequents are not the same, and in the case of the two rules above, no inclusion relation exists according to Patent Document 2. Therefore, substitution processing must be performed for each of the rules. Furthermore, the technique disclosed in Patent Document 2 is solely for selecting a single rule for performing an inference, and it is necessary to perform substitutions for all of the rules in order to verify each rule.

An example object of the present invention is to provide a logical calculation device, a logical calculation method, and a program that solve any of the above problems.

### Means for Solving the Problem

According to a first example aspect of the present invention, a logical calculation device includes: an inclusion extraction unit that extracts a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

According to a second example aspect of the present invention, a logical calculation method is a logical calculation method performed using a computer, the method including: extracting a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

According to a third example aspect of the present invention, a program causes a computer to execute: extracting a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

### Effect of the Invention

According to at least one of the above example aspects, a logical calculation device is capable of reducing the calculation time of a predicate logical formula.

### BRIEF DESCRIPTION OF THE DRAWINGS

FIG. 1 is a block diagram showing an overall configuration of a logical calculation device according to a first example embodiment.

FIG. 2 is a diagram showing examples of input rules.

FIG. 3 is a diagram showing examples of aggregated rules.

FIG. 4 is a diagram showing an example of input data.

FIG. 5 is a diagram showing an example of substitution data relating to the rule “Smoke(x)->Cancer(x)”.

FIG. 6 is a diagram showing an example of substitution data relating to the rule “Smoke(x) AND Friend(x, y)->Friend(y, z)”.

FIG. 7 is a diagram showing an example of substitution data relating to the rule “Smoke(x) AND Friend(x, y)->Friend(y, x)”.

FIG. 8 is a flowchart showing the inference processing by the logical calculation device according to the first example embodiment.

FIG. 9 is a flowchart showing the processing by an inclusion extraction unit according to the first example embodiment.

FIG. 10 is a flowchart showing the processing by an inclusion extraction unit according to the first example embodiment.

FIG. 11 is a flowchart showing the processing by a pre-processing unit according to the first example embodiment.

FIG. 12 is a diagram showing an example of processing that extracts substitution data relating to ID3 from substitution data relating to ID2.

FIG. 13 is a diagram showing an example of processing that extracts substitution data relating to ID4 from substitution data relating to ID2.

FIG. 14 is a flowchart showing the processing by an inference processing unit according to the first example embodiment.

FIG. 15 is a block diagram showing an overall configuration of a logical calculation device according to a second example embodiment.

FIG. 16 is a flowchart showing the learning processing by a logical calculation device according to the second example embodiment.

FIG. 17 is a flowchart showing the processing relating to the second and subsequent repetitions of the processing by an inclusion extraction unit according to the second example embodiment.

FIG. 18 is a flowchart showing the processing relating to the second and subsequent repetitions of the processing by a substitution extraction unit according to the second example embodiment.

FIG. 19 is a flowchart showing the processing by a learning processing unit according to the second example embodiment.

FIG. 20 is a block diagram showing a basic configuration of a logical calculation device.

### EXAMPLE EMBODIMENTS FOR CARRYING OUT THE INVENTION

### <Definitions>

A “variable” is a symbol that represents data, to which elements belonging to a specific set can be assigned. For example, a variable “x” representing a person can be substituted by an element such as “Alice” or “Bob”, which belong to a set relating to people. In the present application, a function term is also included as an example of a variable. For example, a function term “Parent(x)”, which represents the parent of the variable “x”, is treated in the same way as a variable.

A “predicate” is a relational expression that returns a boolean value (1 or 0) that indicates whether or not a variable or a permutation of variables has a predetermined attribute. For example, “Friend( )” is a predicate having an arity of two, and indicates whether or not the first variable is a friend of the second variable. The arity is a value indicating the number of arguments referred to by the predicate.

“Predicate arguments” and “atomic formulas” are terms representing a boolean value composed of one predicate and one or more variables. For example, “Friend(x, y)” is a predicate argument indicating whether or not the variable x is a friend of the variable y.

A “predicate logical formula” is a logical formula representing a boolean value, and is composed of a combination of a plurality of predicate arguments. For example, “Friend(x, y)->Friend(y, x)” is a predicate logical formula representing a rule which establishes that if the variable x is a friend of the variable y, then the variable y is a friend of the variable x.

A “closed formula” is a predicate logical formula that does not include variables. A closed formula can be obtained by substituting elements for all of the variables in a predicate logical formula. For example, “Friend (Alice, Bob)->Friend (Bob, Alice)” is an expression which represents the logic that if Alice is a friend of Bob, then Bob is a friend of Alice. If Friend(Alice, Bob) is true and Friend(Bob, Alice) is true, it can be stated that the closed formula above is true.

### First Example Embodiment

### <<Description of Configuration>>

A first example embodiment for carrying out the invention will be described in detail with reference to the drawings.

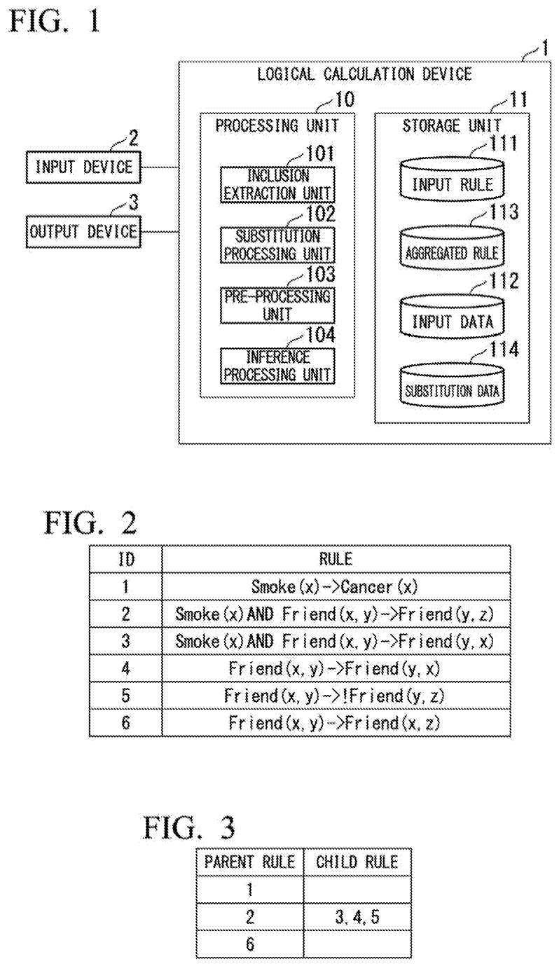

FIG. 1 is a block diagram showing an overall configuration of a logical calculation device according to the first example embodiment.

The logical calculation device 1 according to the first example embodiment performs inference processing based on input data 112 and input rules 111 input by a user. The logical calculation device 1 according to the first example embodiment includes an input device 2, an output device 3, a processing unit 10, and a storage unit 11. The input device 2 receives an input of the input data 112 and the input rules 111. The output device 3 displays the progress of the processing and the inference result. The processing unit 10 executes logical calculation processing. The storage unit 11 holds data for performing the logical calculation processing.

Devices such as a sensor device for acquiring the input data 112, a mouse or keyboard for inputting the input data 112 and the input rules 111, and a computer terminal connected to a network may be used as the input device 2. A display device such as a display or an indicator may be used as the output device 3. The processing unit 10 is realized by an arithmetic device such as a CPU, an FPGA, or a GPU included in a logical network processing system, and a program which is operated by the arithmetic device. Furthermore, the storage unit 11 is realized by a storage device such as an HDD, an SSD, or a memory.

As a result of executing the program, the processing unit 10 functions as an inclusion extraction unit 101, a substitution processing unit 102, a pre-processing unit 103, and an inference processing unit 104.

The inclusion extraction unit 101 performs processing that generates aggregated rules 113 by determining an inclusion relation between the input rules 111, and then aggregating the plurality of rules such that, of the rules having the inclusion relation, the including side is set as the “parent rule” and the included side is set as the “child rule”. A “parent rule” is an example of a first predicate logical formula. A “child rule” is an example of a second predicate logical formula.

The substitution processing unit 102 substitutes input data into the parent rule (primary rule, main rule) of the aggregated rule 113, and generates substitution data 114.

The pre-processing unit 103 extracts, from the substitution data 114 generated using the parent rule, substitution data 114 that can be generated using the child rule (secondary rule, sub-rule).

The inference processing unit 104 performs inference processing using the substitution data 114 generated by the substitution processing unit 102, and the substitution data 114 generated by the pre-processing unit 103.

The storage unit 11 stores the input rules 111, the aggregated rules 113, the input data 112, and the substitution data 114. An input rule 111 is a rule which is input from the input device 2. An aggregated rule 113 is a rule which has been aggregated by the inclusion extraction unit 101. The input data 112 represents boolean values relating to atomic formulas input from the input device 2. The substitution data 114 is data calculated by the substitution processing unit 102.

FIG. 2 is a diagram showing an example of an input rule.

The input rules 111 are data that associate an ID with a rule that relates to the ID. The input rules 111 according to the first example embodiment represent predicate logical formulas described using first-order predicate logic. The rules stored in the input rules are formed by combining a logical connective such as AND, OR, ->, or !, a variable symbol, and a predicate symbol. For example, among the input rules 111 shown in FIG. 2, the rule “Smoke(x)->Cancer(x)” associated with ID1 is a rule meaning that “if the person x smokes, then the person x has cancer”.

FIG. 3 is a diagram showing examples of aggregated rules.

An aggregated rule 113 is data that associates ID of a parent rule with ID of a child rule. In an aggregated rule 113, a plurality of child rules may be associated with a single parent rule. Furthermore, in an aggregated rule 113, there may be no child rule associated with a parent rule.

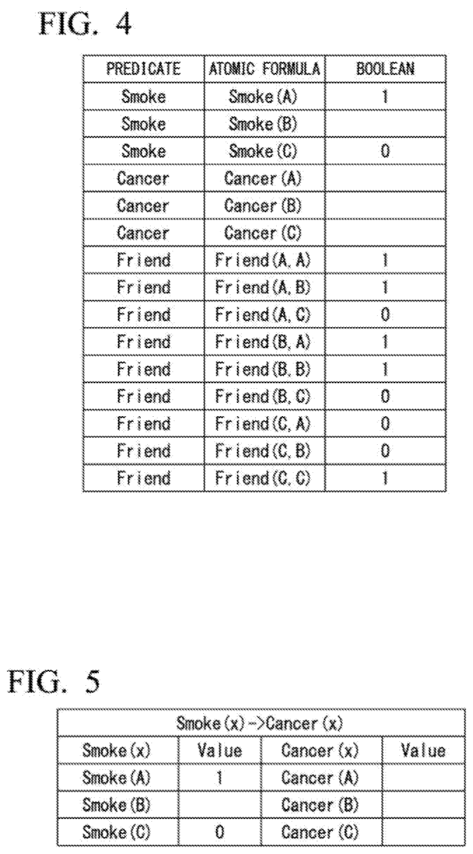

FIG. 4 is a diagram showing an example of input data.

The input data 112 is data that associates a predicate, an atomic formula in which a value (constant) is substituted for the variable of the predicate, and the boolean value taken by the atomic formula. The predicates relating to the input data 112 are the predicates included in the predicate logical formula relating to the input rules 111. The boolean value in an input rule 111 takes the values of 1 (true), 0 (false), or NULL (no value).

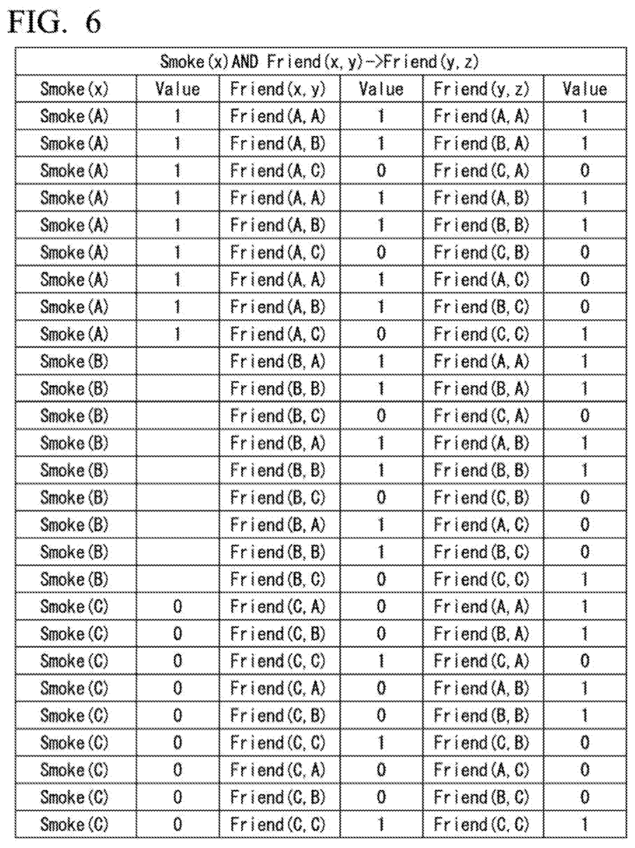

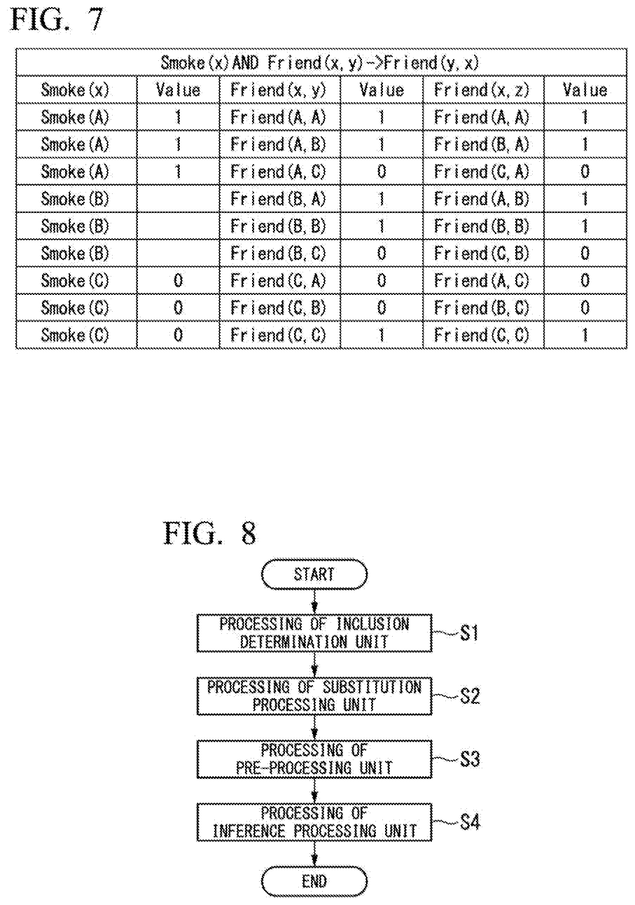

FIG. 5 is a diagram showing an example of substitution data according to the rule “Smoke(x)->Cancer(x)”. FIG. 6 is a diagram showing an example of substitution data according to the rule “Smoke(x) AND Friend(x, y)->Friend(y, z)”. FIG. 7 is a diagram showing an example of substitution data according to the rule “Smoke(x) AND Friend(x, y)->Friend(y, x)”.

The substitution data 114 is data in which, for each rule relating to the input rules 111, a plurality of predicate arguments included in the closed formula, in which each variable of the rule is substituted with an element, is associated with the boolean value of each predicate argument. The substitution data 114 is data obtained by taking a closed formula in each row, and taking combinations of predicate arguments and boolean values in each column.

For example, the closed formulas relating to the rule “Smoke(x)->Cancer(x)” are 3, namely, “Smoke(A)->Cancer(A)”, “Smoke(B) ->Cancer(B)”, and “Smoke(C)->Cancer(C)”. Consequently, as shown in FIG. 5, the substitution data 114 of “Smoke(x)->Cancer(x)” stores the boolean values relating to both the predicate argument “Smoke(A)” and the predicate argument “Cancer(A)” that constitute “Smoke(A)->Cancer(A)”, the boolean values relating to both the predicate argument “Smoke(B)” and the predicate argument “Cancer(B)” that constitute “Smoke(B)->Cancer(B)”, and the boolean values relating to both the predicate argument “Smoke(C)” and the predicate argument “Cancer(C)” that constitute “Smoke(C)->Cancer(C)”.

In the first example embodiment, an example is presented in which the input rule 111, the input data 112, the aggregated rule 113, and the substitution data 114 take the form of a table. However in other example embodiments, the format does not particularly matter as long as the information is equivalent.

### <<Description of Operation>>

An inference operation by the logical calculation device 1 according to the first example embodiment will be described in detail with reference to FIG. 8.

FIG. 8 is a flowchart showing inference processing by the logical calculation device according to the first example embodiment.

The user inputs the input data 112 and the input rules 111 into the logical calculation device 1 via the input device 2. The logical calculation device 1 records the input data 112 and the input rules 111 on the storage unit 11. The user inputs an instruction to start the inference processing, into the logical calculation device 1 via the input device 2.

When the logical calculation device 1 receives an instruction to start the inference processing, the inclusion extraction unit 101 creates aggregated rules 113 from the input rules 111 stored in the storage unit 11 (step S1). That is to say, the inclusion extraction unit 101 creates aggregated rules 113 by extracting from the input rules 111, a parent rule and a child rule, which is a rule included in the parent rule.

Next, the substitution processing unit 102 creates substitution data 114 using the aggregated rules 113, the input rules 111, and the input data 112 (step S2). The substitution processing unit 102 refers to the ID of the parent rule relating to the aggregated rules 113, and substitutes values corresponding to the input data 112 into each of the variables of the rule in the input rules 111 which are associated with the parent rule IDs.

Then, the pre-processing unit 103 extracts substitution data 114 of the child rule from the substitution data 114 of the parent rules generated by the substitution processing unit 102 (step S3). The substitution data 114 relating to the parent rule includes data which is equivalent to the substitution data 114 of the child rule included in the parent rule. The pre-processing unit 103 specifies data which is equivalent to the substitution data 114 of the child rule, and then outputs to the inference processing unit 104 information about the location where the data is stored among the substitution data 114 of the parent rule.

Next, the inference processing unit 104 performs the inference processing using the substitution data 114 generated by the substitution processing unit 102 and the information acquired from the pre-processing unit 103 (step S4). The inference processing unit 104 performs the inference processing to infer values for the NULL values among the substitution data 114.

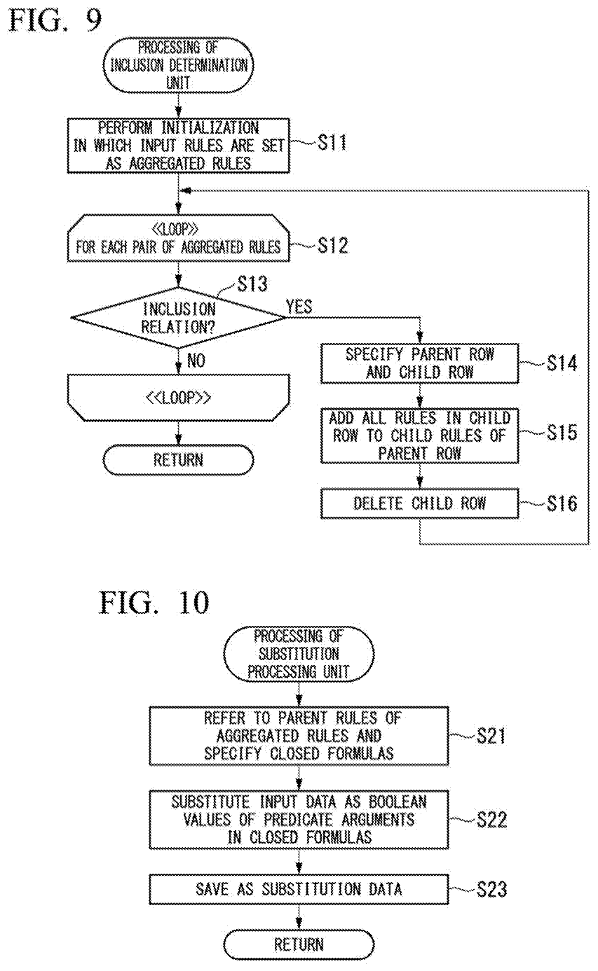

Next, the processing of the inclusion extraction unit 101 relating to step Si above will be described in detail. FIG. 9 is a flowchart showing the processing of the inclusion extraction unit according to the first example embodiment.

The inclusion extraction unit 101 performs initialization in which each of the input rules 111 is set as an aggregated rule 113 (step S11). Specifically, in the case of the input rules 111 shown in FIG. 2, the inclusion extraction unit 101 performs initialization in which the rule of each ID is set as a parent rule, and it is set as an aggregated rule 113 having no child rules. Then, the inclusion extraction unit 101 specifies every pair combination of parent rules in the aggregated rules 113, selects the pairs one by one, and executes the following processing from step S13 to step S14 for all of the pairs (step S12). When the aggregated rules 113 are initialized from the input rules 111 shown in FIG. 2, six aggregated rules 113 are generated, and thus a total of 15 (6C2) pairs are specified.

The inclusion extraction unit 101 determines whether or not the pair selected in step S12 has an inclusion relation (step S13). For example, when the substitution data is created, the inclusion extraction unit 101 determines whether or not an inclusion relation exists between the substitution data created using the parent rule and the substitution data created using the child rule. An “inclusion relation” between rules according to the present example embodiment refers to a relation in which a set of a closed formula of one rule, in which each variable has been substituted with an element, includes a set of a closed formula of the other rule, in which each variable has been substituted with an element. In order to determine whether or not a selected pair of parent rules has an inclusion relation, the inclusion extraction unit 101 evaluates the pair of parent rules under the following conditions.

The inclusion extraction unit 101 specifies a plurality of predicate arguments for each parent rule by deleting the logical connectives included in the parent rule. The inclusion extraction unit 101 specifies a condition of the variables that are expected to have the same value between the specified plurality of predicate arguments. Hereinafter, the condition of the variables that are expected to have the same value between the predicate arguments is also referred to as a “matching condition”.

When “the predicates that constitute the predicate arguments relating to one rule and the number of predicate arguments match the predicates that constitute the predicate arguments relating to another rule and the number of predicate arguments” and “all of the matching conditions of the one rule match some of the matching conditions of the other rule” (first aggregation condition), the inclusion extraction unit 101 evaluates that the pair has an inclusion relation in which the one rule is the parent rule and the other rule is the child rule.

Furthermore, when “some of the plurality of predicates relating to one rule match all of the predicates relating to another rule” and “regarding the predicate arguments that are common to the one rule and the other rule, all of the matching conditions of the one rule match some of the matching conditions of the other rule” (second aggregation condition), the inclusion extraction unit 101 evaluates that the pair has an inclusion relation in which the one rule is the parent rule and the other rule is the child rule.

Here, a rule pair that satisfies the first aggregation condition will be described.

The pair of the rule of ID2 and the rule of ID3 in FIG. 3 is a pair satisfying the first condition. The rule of ID2 is a rule having the predicate argument “Smoke(x)”, the predicate argument “Friend(x, y)”, and the predicate argument “Friend(y, z)”. The rule of ID3 is a rule having the predicate argument “Smoke(x)”, the predicate argument “Friend(x, y)”, and the predicate argument “Friend(y, x)”.

As described above, the predicates constituting the predicate arguments of the rule of ID2 and the predicates constituting the predicate arguments of the rule of ID3 are all “Smoke”, “Friend”, and “Friend”. Furthermore, the number of predicate arguments in the rule of ID2 and the number of predicate arguments in the rule of ID3 are all three. That is to say, the predicates that constitute the predicate arguments relating to the rule of ID3, and the number of the predicate arguments, match the predicates that constitute the predicate arguments relating to the rule of ID2, and the number of the predicates terms.

The matching conditions of the rule of ID2 are that the first variable of the first predicate argument (x of Smoke(x)) matches the first variable of the second predicate argument (x of Friend(x, y)), and the second variable of the second predicate argument (y of Friend(x, y)) matches the first variable of the third predicate argument (y of Friend(y, z)). The matching conditions of the rule of ID3 are that the first variable of the first predicate argument (x of Smoke(x)) matches the first variable of the second predicate argument (x of Friend(x, y)), the second variable of the second predicate argument (y of Friend(x, y)) matches the first variable of the third predicate argument (y of Friend(y, x)), and the first variable of the third predicate argument (x of Friend(x, y)) matches the second variable of the third predicate argument (x of Friend(y, x)).

Here, when the matching conditions of the respective rules are compared, all of the matching conditions of the rule of ID2 match some of the matching conditions of the rule of ID3.

The inclusion extraction unit 101 also evaluates whether or not the matching conditions are the same when the predicates are rearranged. When rearrangement of the predicates results in inclusion by the matching conditions, the inclusion extraction unit 101 determines that the matching conditions of the one rule matches all of the matching conditions of the other rule.

As described above, because the rule of ID2 and the rule of ID3 satisfy the first aggregation condition, the inclusion extraction unit 101 can determine that the rule of ID2 is the parent rule of the rule of ID3. Here, similarly, because the rule of ID4 and the rule of ID5 satisfy the first aggregation condition, the inclusion extraction unit 101 can determine that the rule of ID4 is the parent rule of the rule of ID5. Here, because the matching conditions relating to the variables of the rule of ID4 and the rule of ID5 match each other, the inclusion extraction unit 101 may set either of the rules as the parent rule.

Here, a rule pair that satisfies the second aggregation condition will be described.

The pair of the rule of ID2 and the rule of ID4 in FIG. 3 is a pair satisfying the first condition. The rule of ID2 is a rule having the predicate argument “Smoke(x)”, the predicate argument “Friend(x, y)”, and the predicate argument “Friend(y, z)”. The rule of ID4 is a rule having the predicate argument “Friend(x, y)”, and the predicate argument “Friend(y, x)”.

As described above, the rule of ID2 includes the two “Friend” predicates constituting the rule of ID4. That is to say, some of the plurality of predicates relating to the rule of ID2 match all of the predicates relating to the rule of ID3.

The matching conditions of the rule of ID2 are that the first variable of the first predicate argument (x of Smoke(x)) matches the first variable of the second predicate argument (x of Friend(x, y)), and the second variable of the second predicate argument (y of Friend(x, y)) matches the first variable of the third predicate argument (y of Friend(y, z)). Among these, the matching condition relating to the predicate arguments which is common to the rule of ID4 is that the second variable of the second predicate argument (y of Friend(x, y)) matches the first variable of the third predicate argument (y of Friend(y, z)). Furthermore, the matching conditions of the rule of ID4 are that the second variable of the first predicate argument (y of Friend(x, y)) matches the first variable of the second predicate argument (y of Friend(y, x)), and the first variable of the first predicate argument (x of Friend(x, y)) matches the second variable of the second predicate argument (x of Friend(y, x)).

Here, when the matching conditions of the respective variables are compared, for those predicate arguments that are common to the rule of ID2 and the rule of ID4, some of the matching conditions of the rule of ID2 match all of the matching conditions of the rule of ID4.

As described above, because the rule of ID2 and the rule of ID4 satisfy the second aggregation condition, the inclusion extraction unit 101 can determine that the rule of ID2 is the parent rule of the rule of ID4. Here, similarly, because the rule of ID2 and the rule of ID5 satisfy the second aggregation condition, the inclusion extraction unit 101 can determine that the rule of ID2 is the parent rule of the rule of ID5.

If the inclusion extraction unit 101 determines that the pair selected in step S12 has an inclusion relation (step S13: YES), it specifies from the aggregated rules 113, the row (parent row) having the rule corresponding to the child rule of the pair selected in step S12 as the parent rule and the row (child row) having the rule corresponding to the parent rule as the parent rule (step S14). The inclusion extraction unit 101 adds the ID of the parent rule and the ID of the child rule of the child row to the child rule of the parent row (step S15). The inclusion extraction unit 101 deletes the child row (step S16). When the aggregated rules 113 are updated, the inclusion extraction unit 101 exits the loop of step S12, and performs the processing of step S12 and subsequent steps again based on the aggregated rules 113 after the update.

On the other hand, in step S17, when the pair selected in step S12 does not have an inclusion relation (step S13: NO), the inclusion extraction unit 101 selects the next pair in step S12.

The inclusion extraction unit 101 ends the processing after executing the processing from step S13 to step S14 for every pair combination of parent rules in the aggregated rules 113. When the input rules 111 are as shown in FIG. 2, the aggregated rules 113 resulting from the above processing are as shown in FIG. 3.

Next, the processing of the substitution processing unit 102 relating to step S2 above will be described in detail. FIG. 10 is a flowchart showing the processing of the inclusion extraction unit according to the first example embodiment.

The substitution processing unit 102 specifies the IDs of the parent rules of the aggregated rule 113, and specifies a closed formula in which each variable in the rules which are associated with the IDs among the input rules 111 is substituted with an element (step S21). When the aggregated rules 113 are as shown in FIG. 3, because ID1, ID2, and ID6 are parent rules of the aggregated rules 113, the substitution processing unit 102 specifies a closed formula for these three rules.

The substitution processing unit 102 substitutes the input data 112 as boolean values for the predicate arguments of each of the specified closed formulas (step S22). Then, the substitution processing unit 102 records the data obtained by the substitution in the storage unit 11 as substitution data 114 (step S23). When the input data 112 is as shown in FIG. 4, the substitution data 114 is as shown in FIG. 5, FIG. 6, and FIG. 7.

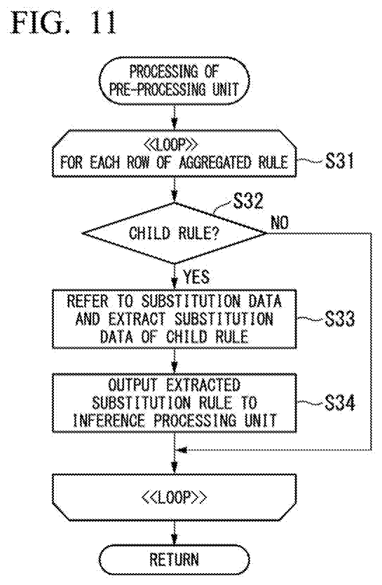

Next, the processing of the pre-processing unit 103 relating to step S3 above will be described in detail. FIG. 11 is a flowchart showing the processing of the pre-processing unit according to the first example embodiment.

The pre-processing unit 103 selects the rows of the aggregated rules 113 one by one, and performs the processing from step S32 to step S34 on the selected row.

The pre-processing unit 103 determines whether or not a child rule exists in the selected row (step S32). If no child rule exists in the selected row (step S32: NO), the pre-processing unit 103 selects the next row in step S31.

If a child rule exists in the selected row (step S32: YES), the pre-processing unit 103 extracts, from the substitution data 114 of the parent rule relating to the selected row, the location that corresponds to the substitution data 114 of each child rule relating to the row (step S33).

For example, when the aggregated rule 113 is as shown in FIG. 3, in the second row of the aggregated rules 113, the rule of ID2 serving as the parent rule is associated with the rules ID3, ID4, and ID5 serving as the child rules. In this case, the pre-processing unit 103 selects, from the substitution data relating to the rule of ID2, the substitution data relating to the rules ID3, ID4, and ID5.

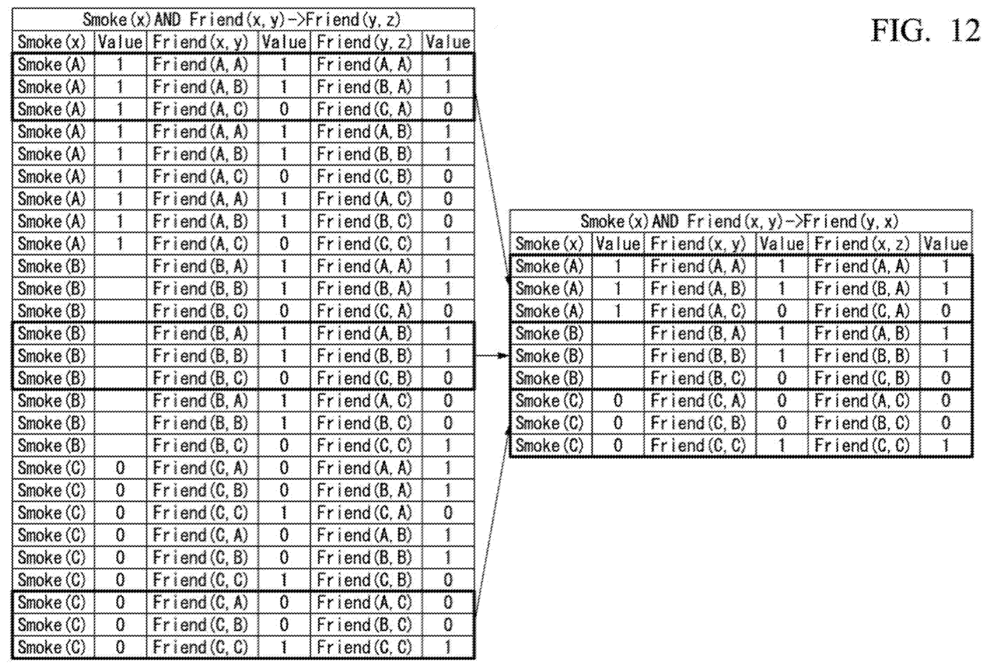

FIG. 12 is a diagram showing an example of the processing that extracts the substitution data associated with ID3 from the substitution data associated with ID2.

The closed formula set relating to the rule of ID2 includes the closed formula set relating to the rule of ID3. Therefore, the substitution data 114 relating to ID2 includes the data corresponding to the substitution data 114 relating to ID3. In FIG. 12, the sections of the substitution data relating to ID2 enclosed by the thick border frames are equivalent to the substitution data 114 relating to ID3.

The pre-processing unit 103 specifies matching conditions relating to the child rule, and extracts, from the substitution data 114 relating to the parent rule, the rows that satisfy all of the matching conditions. More specifically, the rows are extracted from the substitution data 114 relating to the parent rule that satisfy all of the matching conditions relating to the child rule which are not common to the matching conditions relating to the parent rule.

In the example shown in FIG. 12, the matching conditions of the rule of ID3, which is a child rule, are that the first variable of the first predicate argument (x in Smoke(x)) matches the first variable of the second predicate argument (x in Friend(x, y)), the second variable of the second predicate argument (y in Friend(x, y)) matches the first variable of the third predicate argument (y in Friend(y, x)), and the first variable of the second predicate argument (x in Friend(x, y)) matches the second variable of the third predicate argument (x in Friend(y, x)). Among these, the matching condition which is not common with those of the rule of ID2, which is the parent rule, is the condition that the first variable of the second predicate argument matches the second variable of the third predicate argument. Therefore, the pre-processing unit 103 extracts, from the substitution data 114 relating to ID2, data which corresponds to the substitution data 114 relating to ID3 by extracting data where the first variable of the second predicate argument matches the second variable of the third predicate argument.

The pre-processing unit 103 may, for example, create the substitution data 114 relating to the child rule by copying data from the substitution data 114 relating to the parent rule. Alternatively, it may specify, within the substitution data 114 relating to the parent rule, the row numbers or the addresses in the storage unit 11 that contains the data corresponding to the substitution data 114 relating to the child rule.

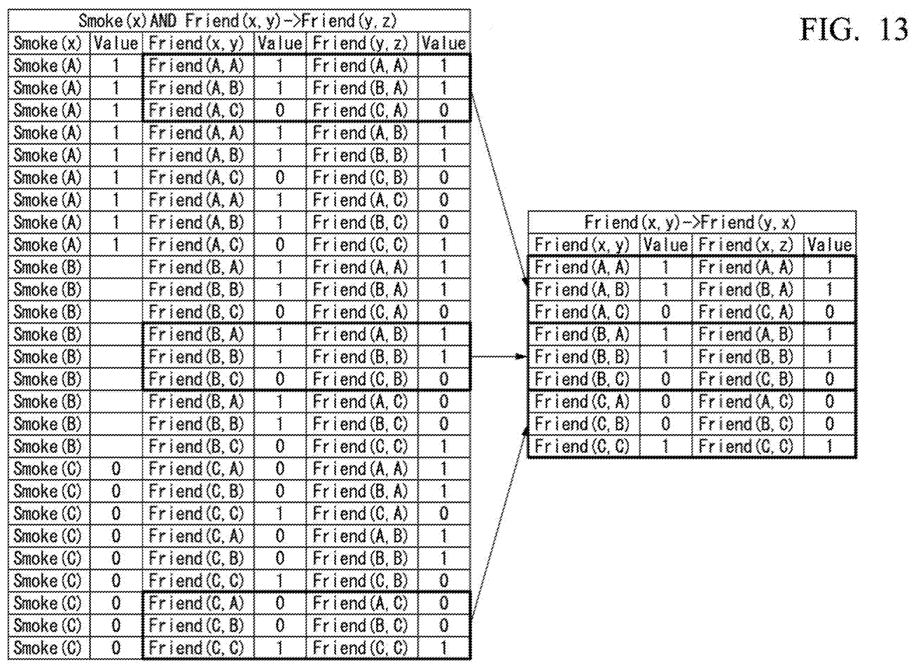

FIG. 13 is a diagram showing an example of the processing that extracts the substitution data associated with ID4 from substitution data associated with ID2. The substitution data 114 relating to the child rule extracted based on the first extraction condition is extracted from the rows of the parent rule as shown in FIG. 12. On the other hand, the substitution data 114 relating to the child rules extracted based on the second extraction condition is extracted from columns that relate to the common predicate arguments within the rows of the parent rule as shown in FIG. 13.

When the substitution data 114 relating to the child rule is extracted, the pre-processing unit 103 outputs the substitution data 114 to the inference processing unit 104 (step S34).

The processing ends when the pre-processing unit 103 has performed the processing from step S32 to step S34 for all of the rows of the aggregated rules 113.

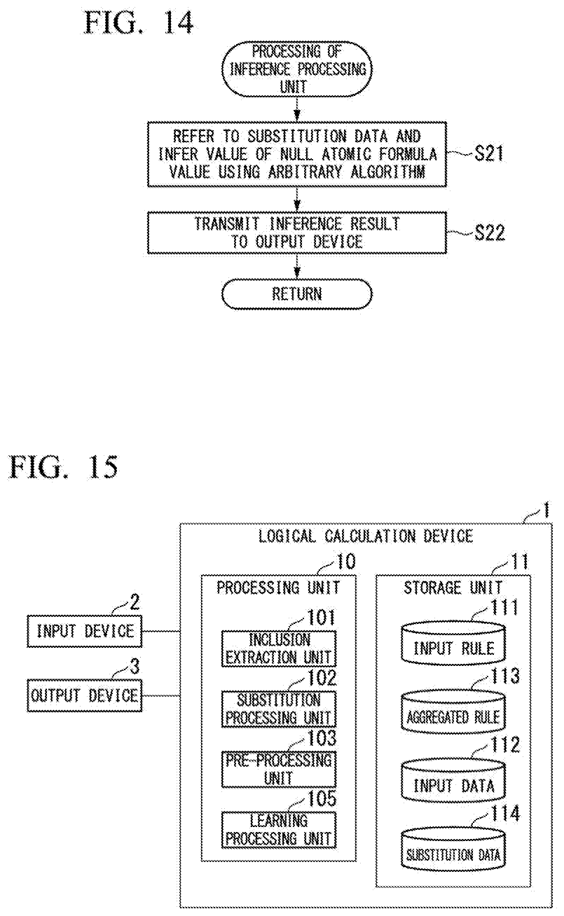

Next, the processing of the inference processing unit 104 relating to step S4 above will be described in detail. FIG. 14 is a flowchart showing the processing of the inference processing unit according to the first example embodiment.

The inference processing unit 104 infers, for all of the rules relating to the input rule 111, a boolean value for atomic formulas which are NULL in the substitution data generated by the substitution processing unit 102 or the substitution data acquired from the pre-processing unit 103 (step S41). The inference processing unit 104 can infer estimated values of the NULL values using an arbitrary algorithm such as machine learning (for example, an algorithm such as a regression model or a Markov network). Then, the inference processing unit 104 transmits the inference result to the output device 3 (step S42), and ends the processing.

### <<Description of Effects>>

As described above, in the logical calculation device 1 according to the first example embodiment, the inclusion extraction unit 101 generates the aggregated rule 113, in which the input rules 111 are aggregated. As a result, the number of substitution operations performed by the substitution processing unit 102 can be reduced, and the overall speed of the inference processing in the logical calculation device 1 can be increased. Furthermore, when the pre-processing unit 103 outputs row numbers or addresses of the substitution data 114 of the parent data to the inference processing unit 104 as the substitution data 114 of the child data, the amount of substitution data 114 generated by the logical calculation device 1 can be reduced. Therefore, the logical calculation device 1 can perform inference processing even when the capacity of the storage unit 11 is small.

### Second Example Embodiment

### <<Description of Configuration>>

FIG. 15 is a block diagram showing an overall configuration of a logical calculation device according to a second example embodiment.

A logical calculation device 1 according to the second example embodiment performs learning processing of rules based on input data 112 and an input rule 111 input by a user. The logical calculation device 1 according to the second example embodiment includes a learning processing unit 105 instead of the inference processing unit 104 of the first example embodiment. The learning processing unit 105 performs learning processing, which updates the input rules 111 using the substitution data 114 generated by the substitution processing unit 102 and substitution data 114 acquired from the pre-processing unit 103.

### <<Description of Operation>>

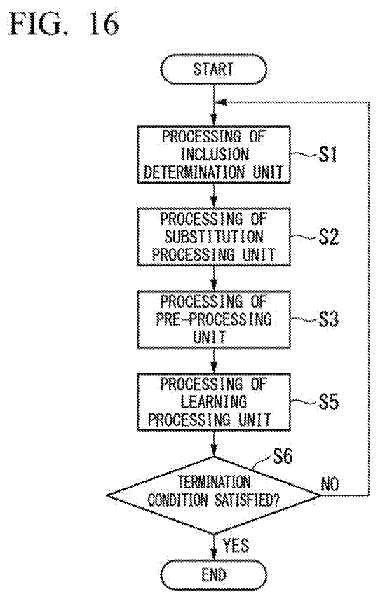

FIG. 16 is a flowchart showing the learning processing by the logical calculation device according to the second example embodiment.

A user inputs the input data 112 and the input rules 111 into the logical calculation device 1 via the input device 2. The logical calculation device 1 records the input data 112 and the input rules 111 in the storage unit 11. The user inputs an instruction to start the learning processing, into the logical calculation device 1 via the input device 2.

When the logical calculation device 1 receives the instruction to start the learning processing, the logical calculation device 1 executes the processing from step Si to step S3 in the same manner as in the first example embodiment. That is to say, the inclusion extraction unit 101 creates the aggregated rules 113, the substitution processing unit 102 creates the substitution data 114 of the parent rules, and the pre-processing unit 103 extracts the substitution data 114 of the child rules. As described later, the processing of the inclusion extraction unit 101 and the processing of the substitution processing unit 102 associated with the second and subsequent repetitions are different from the processing of the first repetition.

Next, the learning processing unit 105 performs learning processing using the substitution data 114 generated by the substitution processing unit 102 and the information acquired from the pre-processing unit 103 (step S5). The learning processing unit 105 evaluates the certainty of the input rules using the substitution data. Furthermore, the learning processing unit 105 updates the input rule 111 as a result of the learning processing.

The learning processing unit 105 determines whether or not the result of the learning processing satisfies a termination condition of the learning processing (step S6). Examples of the termination condition of the learning process may include that the number of repetitions of the learning processing exceeds a predetermined number, or that an evaluated value of the certainty of a rule exceeds a predetermined threshold.

If the result of the learning processing does not satisfy the termination condition of the learning processing (step S6: NO), the logical calculation device 1 returns the processing to step Si and performs the processing again. On the other hand, if the result of the learning processing satisfies the termination condition of the learning processing (step S6: YES), the logical calculation device 1 terminates the learning processing.

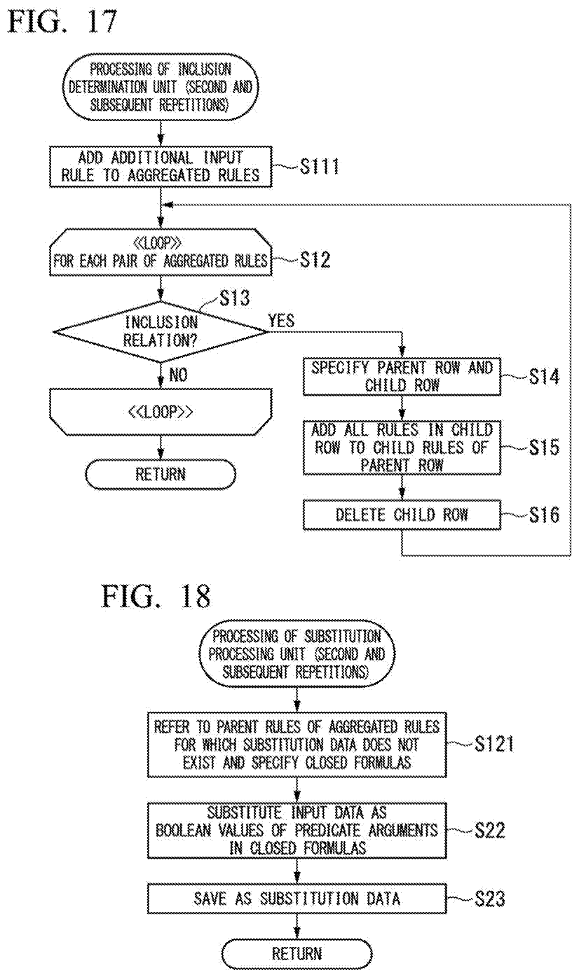

Next, the processing of the inclusion extraction unit 101 relating to step Si above will be described in detail. FIG. 17 is a flowchart showing the processing relating to the second and subsequent repetitions of the processing by the inclusion extraction unit according to the second example embodiment.

The inclusion extraction unit 101 performs initialization in which the rules among the input rules 111 that were added as a result of the learning processing of step S5 are set as aggregated rules 113 and adds them (step S111). That is to say, the inclusion extraction unit 101 retains as is the aggregated rules 113 relating to the set of rules for which an inclusion relation has already been determined. Consequently, the inclusion extraction unit 101 can reduce the calculation processing for the second and subsequent repetitions. Thereafter, the inclusion extraction unit 101 executes the processing from step S12 to step S16 in the same manner as in the first example embodiment.

Next, the processing of the substitution processing unit 102 relating to step S2 above will be described in detail. FIG. 18 is a flowchart showing the processing relating to the second and subsequent repetitions of the processing by the substitution extraction unit according to the second example embodiment.

The substitution processing unit 102 specifies the IDs of the parent rules of the aggregated rules 113 for which substitution data 114 does not exist, and specifies a closed formula in which each variable in the input rules 111 which are associated with the IDs has been substituted with an element (step S121). That is to say, the substitution processing unit 102 does not perform substitution processing with respect to those aggregated rules 113 that have already been subjected to substitution processing. As a result, the substitution processing unit 102 can reduce the number of times of substitution processing performed in the second and subsequent repetitions. Thereafter, the substitution processing unit 102 executes the processing from step S22 to step S23 in the same manner as in the first example embodiment.

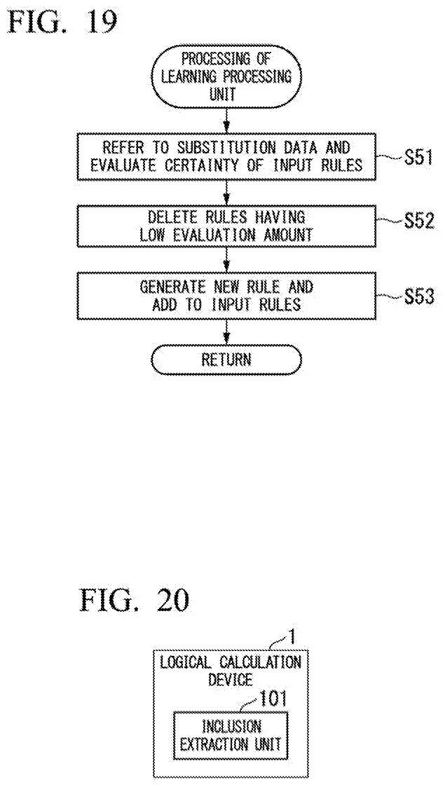

Next, the processing of the learning processing unit 105 relating to step S5 above will be described in detail. FIG. 19 is a flowchart showing the processing by the learning processing unit according to the second example embodiment.

The learning processing unit 105 refers to the substitution data to evaluate the certainty of the input rules 111 (step S51). Here, the learning processing unit 105 calculates an evaluation value indicating how correct the content of the input data 112 is with respect to the input rules 111. For example, the learning processing unit 105 can calculate, as the evaluation value, a ratio of the rule being true in the substitution data 114 relating to each rule. For example, the learning processing unit 105 may calculate the likelihood of a rule using an arbitrary machine learning algorithm (such as a stochastic gradient descent method), and use the value as an evaluation value. The learning processing unit 105 deletes from the input rule 111 those rules having an evaluation value that is smaller than a predetermined value (step S52).

Next, the learning processing unit 105 creates a new rule and adds the rule to the input rules 111 (step S53). The learning processing unit 105 may generate the new rule using an arbitrary algorithm. For example, the learning processing unit 105 can randomly create a rule representing a combination that has not been set as an input rule 111 in the past, and add the rule as an input rule 111.

### <<Description of Effects>>

As described above, the logical calculation device 1 according to the second example embodiment is capable of operating at high speeds by omitting processing relating to the processing of the inclusion extraction unit 101 and the processing of the substitution processing unit 102 in the second and subsequent repetitions by reusing the information already calculated prior to the repetition. In a similar manner to a case where the rules are not aggregated, the same is applicable to a case where an inclusion relation is determined and the rules are aggregated.

A plurality of example embodiments have been described in detail above with reference to the drawings. However, the specific configuration is not limited to the description above, and various design changes and the like can be made.

### <Basic Configuration>

FIG. 20 is a block diagram showing a basic configuration of a logical calculation device.

In the example embodiments above, the configurations shown in FIG. 1 and FIG. 15 have been described as example embodiments of the logical calculation device 1. However, a basic configuration of the logical calculation device 1 is as illustrated in FIG. 20.

That is to say, the logical calculation device 1 includes the inclusion extraction unit 101 as a basic configuration.

The inclusion extraction unit 101 extracts a set of predicate logical formulas from a plurality of predicate logical formulas which include a plurality of predicate arguments including one predicate and one or more variables, in which a closed formula set in which each variable in a first predicate logical formula has been substituted with a value includes a closed formula set in which each variable in a second predicate logical formula has been substituted with a value.

Therefore, the logical calculation device 1 is capable of reducing the calculation time of a predicate logical formula.

A program for realizing some or all of the processing performed by the logical calculation device 1 may be recorded on a computer-readable recording medium, and the processing of each unit may be performed by a computer system reading and executing the program recorded on the recording medium. The “computer system” referred to here includes an OS and hardware such as a peripheral device.

Furthermore, the “computer-readable recording medium” refers to a portable medium such as a flexible disk, a magnetic optical disk, a ROM, or a CD-ROM, or a storage device such as a hard disk built into a computer system. Moreover, the program may be one capable of realizing some of the functions described above. Further, the functions described above may be realized in combination with a program already recorded in the computer system.

This application claims priority based on Japanese Patent Application No. 2017-252612, filed Dec. 27, 2017, the entire disclosure of which is incorporated herein.

### INDUSTRIAL APPLICABILITY

The present invention may be applied to a logical calculation device, a logical calculation method, and a program.

### REFERENCE SYMBOLS

1 Logical calculation device
2 Input device
3 Output device
10 Processing unit
11 Storage unit
101 Inclusion extraction unit
102 Substitution processing unit
103 Pre-processing unit
104 Inference processing unit
111 Input rule
112 Input data
113 Aggregated rule
114 Substitution data
105 Learning processing unit

What is claimed is:

1. A logical calculation device comprising:
a memory that stores instructions:
a processor configured to execute the instructions to:
extract a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

2. The logical calculation device according to claim 1,
wherein the processor is configured to execute the instructions to:
substitute a predetermined boolean value into a predicate argument of a plurality of closed formulas relating to the first predicate logical formula among the extracted set of the first and the second predicate logical formulas.

3. The logical calculation device according to claim 2,
wherein the processor is configured to execute the instructions to:
extract, by using a boolean value relating to the plurality of closed formulas a boolean value relating to a plurality of closed formulas relating to the second predicate logical formula among the extracted set of the first and the second predicate logical formulas.

4. The logical calculation device according to claim 1,
wherein the processor is configured to execute the instructions to:
specify, with respect to each predicate logical formula, a condition of variables expected to have the same value in a plurality of predicate arguments, and extracts the set of the first and the second predicate logical formulas based on the condition of the variables relating to each predicate logical formula.

5. The logical calculation device according to claim 4, wherein a predicate constituting the predicate argument relating to the first predicate logical formula and the number of the predicate argument matches a predicate constituting the predicate argument relating to the second predicate logical formula and the number of the predicate argument, and all of the condition of the variables of the first predicate logical formula match some of the condition of the variables of the second predicate logical formula.

6. The logical calculation device according to claim 4, wherein some of a plurality of predicates relating to the first predicate logical formula match all predicates relating to the second predicate logical formula, and for the condition of the variables relating to predicates which are common to the first predicate logical formula and the second predicate logical formula, all of the condition of the variables of the first predicate logical formula matches some of the condition of the variables of the second predicate logical formula.

7. A logical calculation method performed using a computer, the method comprising:
extracting a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.

8. A non-transitory computer readable recording medium storing a program for causing a computer to execute:
extracting a set of first and second predicate logical formulas from a plurality of predicate logical formulas, each of the plurality of predicate logical formulas including a plurality of predicate arguments that include one predicate and one or more variables, a set of a closed formula in which each variable in the first predicate logical formula is substituted with a value including a set of a closed formula in which each variable in the second predicate logical formula is substituted with a value.
